(19) United States
(12) Patent Application Publication
(10) Pub. No.: US 2013/0024483 A1
(43) Pub. Date: Jan. 24, 2013

(54) DISTRIBUTION OF DATA WITHIN A DATABASE

(71) Applicants: Michael A. Mohr, Stittsville (CA); Shaun P. Hennessy, Nepean (CA)

(72) Inventors: Michael A. Mohr, Stittsville (CA); Shaun P. Hennessy, Nepean (CA)

(73) Assignee: Alcatel-Lucent Canada, Inc., Ottawa (CA)

(21) Appl. No.: 13/188,065

(22) Filed: Jul. 21, 2011

(51) Int. Cl. G06F 17/30

(52) U.S. Cl. 707/822; 707/E17.005; 707/E17.032

(57) ABSTRACT

Various exemplary embodiments relate to a method and related network node including one or more of the following: retrieving, by the database controller, a record to be stored; identifying a record type associated with the record; identifying at least one storage device of the plurality of storage devices that stores records of the identified record type; and storing the record in a storage device of the plurality of storage devices other than the at least one storage device identified as storing records of the identified record type. Various embodiments additionally include one or more of the following: identifying a record type associated with the record by identifying a record type of at least one other record upon which the record depends.

### TECHNICAL FIELD

Various exemplary embodiments disclosed herein relate generally to data storage.

### BACKGROUND

In the decades since its invention, the database has become ubiquitous in its myriad of applications. Databases are used today to store and retrieve virtually every type of data, such as records of inventory, sales, accounts, subscriptions, and usage statistics. Many such applications utilize very large amounts of data and may therefore require terabytes, or even greater amounts, of storage space. While capacities of storage devices are constantly increasing, considerations such as cost and scaling oftentimes render solutions utilizing only a single storage device impractical. Accordingly, many databases store data amongst a number of discrete storage devices.

The storage of a single database on a number of separate devices introduces other considerations, however. For example, some decision must be made as to which storage devices should store which data. Further, requested data must first be located on one of the devices prior to retrieval. While various methods of implementing multiple storage devices for a single database have been developed, these methods commonly suffer from various inefficiencies that ultimately have a negative impact on the performance of the database.

### SUMMARY

Various exemplary embodiments relate to a method performed by a database controller for distributing data among a plurality of storage devices, the method including one or more of the following: retrieving, by the database controller, a record to be stored; identifying a record type associated with the record; identifying at least one storage device of the plurality of storage devices that stores records of the identified record type; and storing the record in a storage device of the plurality of storage devices other than the at least one storage device identified as storing records of the identified record type.

Various exemplary embodiments relate to a system for distributing data among a plurality of storage devices, the system including one or more of the following: a storage device interface for communicating with the plurality of storage devices; a dependent record generator configured to generate a dependent record to be stored on the plurality of storage devices based upon at least one other record currently stored on the plurality of storage devices; a record distributor configured to: identify a record type associated with the record, identify at least one storage device of the plurality of storage devices that stores records of the identified record type, and transmit the dependent record via the storage device interface to a storage device other than the at least one storage device identified as storing records of the identified record type.

Various exemplary embodiments relate to a tangible and non-transitory machine-readable medium encoded with instructions for execution on a database controller for distributing data among a plurality of storage devices, the machine-readable medium including one or more of the following: instructions for retrieving, by the database controller, a record to be stored; instructions for identifying a record type associated with the record; instructions for identifying at least one storage device of the plurality of storage devices that stores records of the identified record type; and instructions for storing the record in a storage device of the plurality of storage devices other than the at least one storage device identified as storing records of the identified record type.

Various embodiments are described wherein the step of identifying a record type associated with the record includes identifying a record type of at least one other record upon which the record depends.

Various embodiments are described wherein the record is an aggregate record based upon the at least one other record.

Various embodiments are described wherein a record type is at least partially defined by a value carried by records having that record type.

Various embodiments are described wherein the step of retrieving a record to be stored includes retrieving a record from a set of records to be stored.

Various embodiments are described wherein the step of storing the record in a storage device of the plurality of storage devices other than the at least one storage device identified as storing records of the identified record type includes one or more of the following: selecting a first storage device of the plurality of storage devices according to a data distribution method applied to the set of records to be stored; determining whether the first storage device is included in the at least one storage device identified as storing records of the identified record type; and if the first storage device is included in the at least one storage device identified as storing records of the identified record type, selecting a second storage device of the plurality of storage devices.

Various embodiments are described wherein the data distribution method is round robin.

### BRIEF DESCRIPTION OF THE DRAWINGS

In order to better understand various exemplary embodiments, reference is made to the accompanying drawings, wherein:

FIG. 1 illustrates an exemplary system for implementing a database;

FIG. 2 illustrates an exemplary first data set to be stored in a database;

FIG. 3 illustrates an exemplary distribution of a data set among a number of storage devices;

FIG. 4 illustrates an exemplary second data set to be stored in a database;

FIG. 5 illustrates an exemplary distribution of data sets among a number of storage devices;

FIG. 6 illustrates an exemplary database controller for distributing records among a plurality of storage devices;

FIG. 7 illustrates an exemplary data arrangement for storing data type mappings;

FIG. 8 illustrates an exemplary data arrangement for storing data type locations;

FIG. 9 illustrates an exemplary method for distributing data sets among a number of storage devices; and

FIG. 10 illustrates an exemplary distribution of data sets among a number of storage devices.

### DETAILED DESCRIPTION

In view of the foregoing, there is a need for a database meₜhod and system that optimizes storage and retrieval of data among a plurality of storage devices. Further, it would be desirable for such as system to leverage the independence of such storage devices from one another to improve system performance during compound database operations.

Referring now to the drawings, in which like numerals refer to like components or steps, there are disclosed broad aspects of various exemplary embodiments. It should be noted that, while various embodiments are described herein related to tracking of sales data, the methods and systems described herein may be generally applied to any database system. For example, the methods and systems described herein may be implemented in a system that stores subscriber usage statistics reported by various network routers.

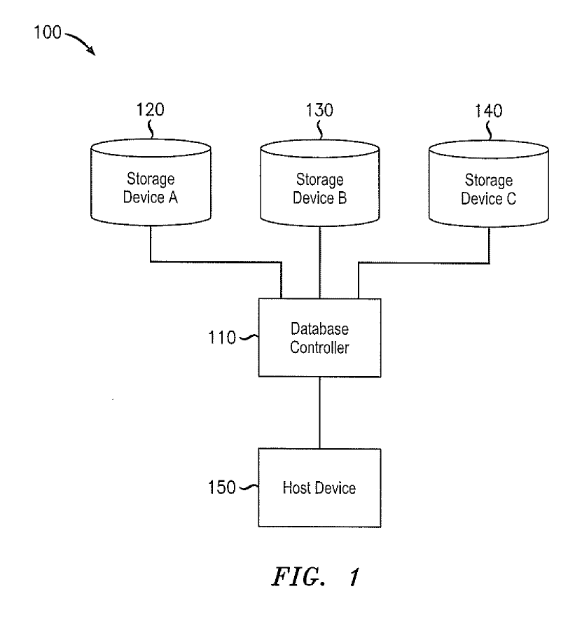

It will be understood that, while various embodiments are described as relating to a database, various hardware may implement such a database. As will be described in greater detail below with respect to FIG. 1, such hardware may include microprocessors, system memory, storage media, and/or interfaces to various other devices.

FIG. 1 illustrates an exemplary system 100 for implementing a database. Exemplary system 100 may include a database controller 110, storage devices 120, 130, 140, and a host device 150.

Database controller 110 may be a device configured to coordinate storage and retrieval of data among storage devices 120, 130, 140. In various embodiments, database controller 110 may include a RAID controller. Database controller 110 may implement other functions, such as report generation, data mining, and/or data aggregation. Various additional functions may include the generation of additional records for storage within the database, such as for example, aggregate or summary records. In various embodiments, database controller 110 may constitute a standalone device or may be incorporated in another device such as host device 150.

Database controller 110 may be further adapted to distribute a number of records to be stored in the database among a number of storage devices 120, 130, 140. In doing so, database controller 110 may group records of the same data type together, such that those records are stored together on the same storage device. To identify a data type of a record, database controller 110 may include a description of each type of record to be stored. For example, database controller 110 may include a description identifying a sales entry record as including store, date, item, quantity, and price columns (as will be described in further detail below). This information may also include an identification of one or more columns as a key field. For example, the store and date fields may both be identified as keys. Thereafter, database controller may identify each unique combination of key values as a unique data type. For example, sales records associated with a “north” store on March 1 may belong to a different data type than sales records associated with a “south” store on March 1. For the purposes of the examples provided herein, it will be assumed that such store and date fields are key fields. However, it will be understood that various embodiments may specify any combination of available fields for a table as key fields. It will further be understood that alternative tables may be used in connection with the methods and systems described herein.

Storage devices 120, 130, 140, may each be a device configured to store data. Each device may include one or more storage media such as, for example, electronic, magnetic, and/or optical media. Each of storage devices 120, 130, 140 may be incorporated within database controller 110, may be collocated with database controller 110, or may be located at a remote location and communicate with database controller 110 via a network such as, for example, the Internet, a local area network (LAN), or a storage area network (SAN). It should be appreciated that, while three storage devices 120, 130, 140 are illustrated, various embodiments may include fewer or additional storage devices. Further, in various embodiments, the number of storage devices 120, 130, 140 may be altered over time. For example, in such embodiments, as the data stored within the database grows and more space is needed, additional storage devices (not shown) may be added to the system.

Host device 150 may be any device adapted to access a database managed by database controller 110. Host device 150 may include database controller 110 as a component thereof, may be collocated with database controller 110, or may communicate with database controller via a network.

Host device 150 may be adapted to interface with database controller 110 in a number of ways. In various embodiments, host device 150 may collect and transmit raw data or database records to database controller 110 for storage. Additionally or alternatively, host controller 150 may form and transmit database queries to database controller 110 and/or may instruct database controller 110 to perform additional functions such as data aggregation. In various embodiments, host device 150 may be a router that collects subscriber usage statistics and transmits such data to database controller 110. Alternatively, host device 150 may be a user device such as, for example, a personal computer, that interfaces with database controller 110 to provide a user access to the database. It should be understood that, while one host device is illustrated in system 100, various embodiments may include numerous additional host devices (not shown) which may be similar to or different from host device 150.

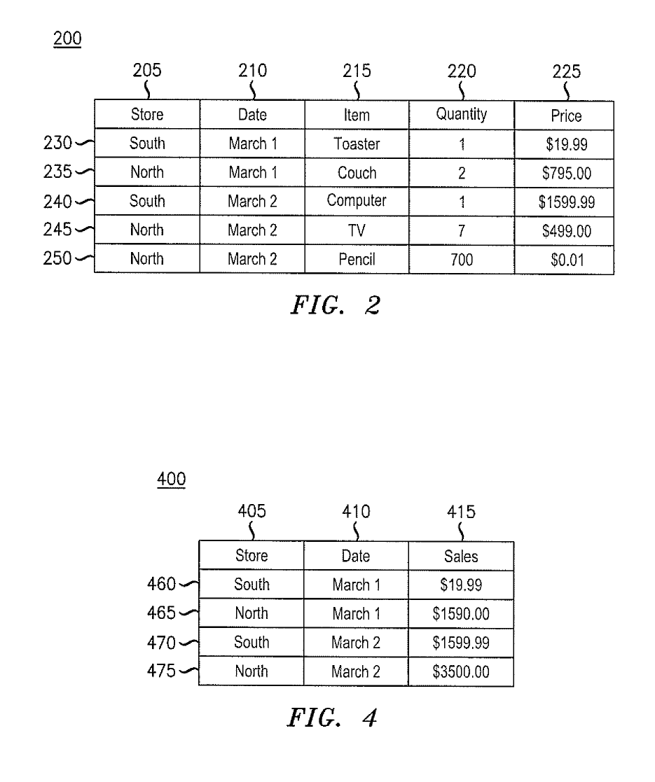

FIG. 2 illustrates an exemplary first data set 200 to be stored in a database. Once stored, data set 200 may be a table in a database. Alternatively, data set 200 may be a series of linked lists, an array, or a similar data structure. Thus, it should be apparent that data set 200 is an abstraction of the underlying data; any data structure suitable for storage of this data may be used.

Exemplary data set 200 may include a number of records of sales among a number of stores. Data set 200 may include a number of fields such as store field 205, date field 210, item field 215, quantity field 220, and price field 225. Store field 205 may indicate a store that made a sale. Date field 210 may indicate a date upon which a sale occurred. Item field 215 may indicate an inventory item that was sold. Quantity field 220 may indicate a quantity of an indicated item that was sold. Price field 225 may indicate a price per unit of an indicated item that was sold.

As an example, sale record 230 indicates that on March 1, the south store sold one toaster at a price of $19.99. Sales record 235 indicates that on March 1, the north store sold two couches at a price of $795.00 each. Sales record 240 indicates that on March 2, the south store sold one computer at a price of $1599.99. Sales record 245 indicates that on March 2, the north store sold seven televisions at a price of $499.00 each. Sales record 250 indicates that on March 2, the north store sold 700 pencils at a price of $0.01 each.

FIG. 3 illustrates an exemplary distribution 300 of a data set among a number of storage devices 120, 130, 140. As previously noted, various embodiments may include fewer or more storage devices. In various embodiments, a database controller, such as database controller 110, may group similar records such that they may be stored together. In the present example, the sales records of data set 200 may be grouped according to the values stored in store field 205 and date field 210, which may be configured as key fields for this data set 200. Such a grouping may yield four distinct data types: “South/March 1 Entry,” “North/March 1 Entry,” “South/March 2 Entry,” and “North/March 2 Entry.”

To store data set 200, database controller 110 may distribute each of the groups among the available storage devices 120, 130, 140, according to some data distribution method. In various embodiments, this data distribution may be a round robin distribution method. Various alternative distribution methods will be apparent to those of skill in the art.

In a system utilizing the round robin method, database controller 110 may begin with sales record 330 as the sole record of the “South/March 1 Entry” data type. As the first record to be distributed, database controller 110 may store sales record 330 in storage device A 120. Next, database controller 110 may proceed to sales record 335, as the sole record of the “North/March 1 Entry” data type. Database controller 110 may move on to the next storage device, storage device B 130, and store sales record 335 there. Likewise, database controller 110 may store sales record 340, the sole record of the “South/March 2 Entry” data type, in the next storage device, storage device C 140. Finally, database controller 110 may return to the first storage device, storage device A 120, to store sales records 345, 350, the two records of the “North/March 2 Entry” data type. Accordingly, data set 200 may be stored among storage devices 120, 130, 140 in a distributed fashion.

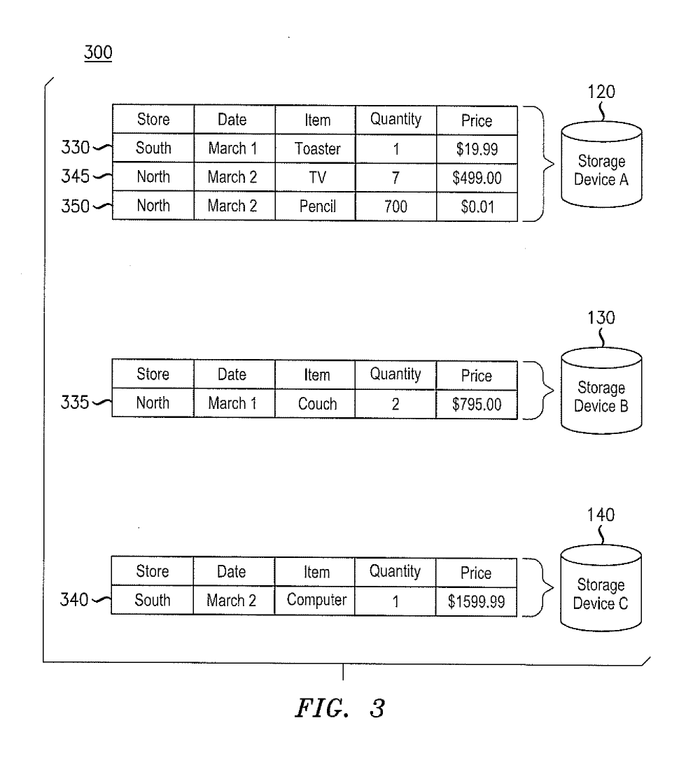

FIG. 4 illustrates an exemplary second data set 400 to be stored in a database. Data set 400 may be derived from data set 200. For example, data set 400 may include a number of records that aggregate the sales from each store on each date. As such, each aggregate record 460, 465, 470, 475 may be dependent on one or more records in data set 200.

Data set 400 may include a number of fields such as store field 405, data field 410, and sales field 415. Store field 405 may indicate a store that made a sale. Date field 410 may indicate a date upon which a sale occurred. Sales field 415 may indicate a total amount of money collected by a store of a particular date.

As an example, aggregate record 460 indicates that on March 1, the south store collected $19.99 in sales. Aggregate record 465 indicates that on March 1, the north store collected 1590.00 in sales. Aggregate record 470 indicates that on March 2, the south store collected $1599.99 in sales. Finally, aggregate record 475 indicates that on March 2, the north store collected $3500.00 in sales.

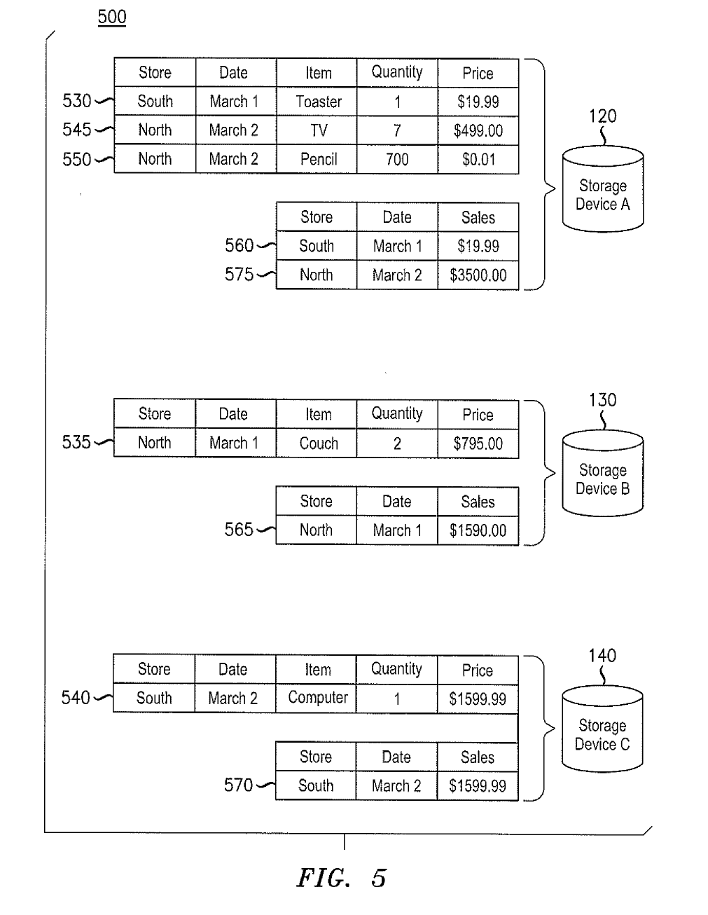

FIG. 5 illustrates an exemplary distribution 500 of data sets among a number of storage devices. Exemplary distribution 500 may include data set 200 distributed in a similar manner to that described above in connection with FIG. 3. Exemplary distribution 500 may also include data set 400, distributed in a manner similar to the distribution of data set 200.

As with data set 200, a database controller (not shown) may distribute aggregate records 460, 465, 470, 475 according to their data types. In the present example, data set 400 may include similar key fields to data set 200. However, it will be noted that different key fields may be used. For example, data set 200 may include store field 205 and date field 210 as key fields, while data set 400 may include Only store field 405 has a key field. In this example, the database controller 400 may group aggregate records 460, 470 together, because both include the same value in key field store field 405. For the purposes of the remaining examples, however, store field 405 and date field 410 may both be key fields.

The database controller (not shown) may begin with record 560, the sole “South/March 1 Aggregate” data type, and store it in the first storage device, storage device A 120. Next, the database controller (not shown) may store aggregate record 565, the sole “North/March 1 Aggregate” data type, in the next storage device, storage device B 130. The database controller (not shown) may then move on to the “South/March 2 Aggregate” data type, and store aggregate record 570 in storage device C 140. Finally, the database controller (not shown) may cycle back to storage device A 120, and store aggregate record 575 there, as the sole “North/March 2 Aggregate” data type.

It should be apparent that various inefficiencies are inherent in the above-described data distribution. As demonstrated, each aggregate record is stored on the same storage device as the sales records on which it depends. For example, aggregate record 575 is stored on storage device A 120 along with sales records 545, 550, from which the sales figure of aggregate record 575 was generated. In such a system, the database accesses used to create and store aggregate record 575 were both directed to storage device A 120, leaving storage device B 130 and storage device C 140 idle. A similar issue would be encountered for a query that requests all “North/March 2” type records. At such times, only ⅓ of the system's database modification capabilities are being utilized. Accordingly, various methods and systems described below may be directed to improving this utilization during such operations.

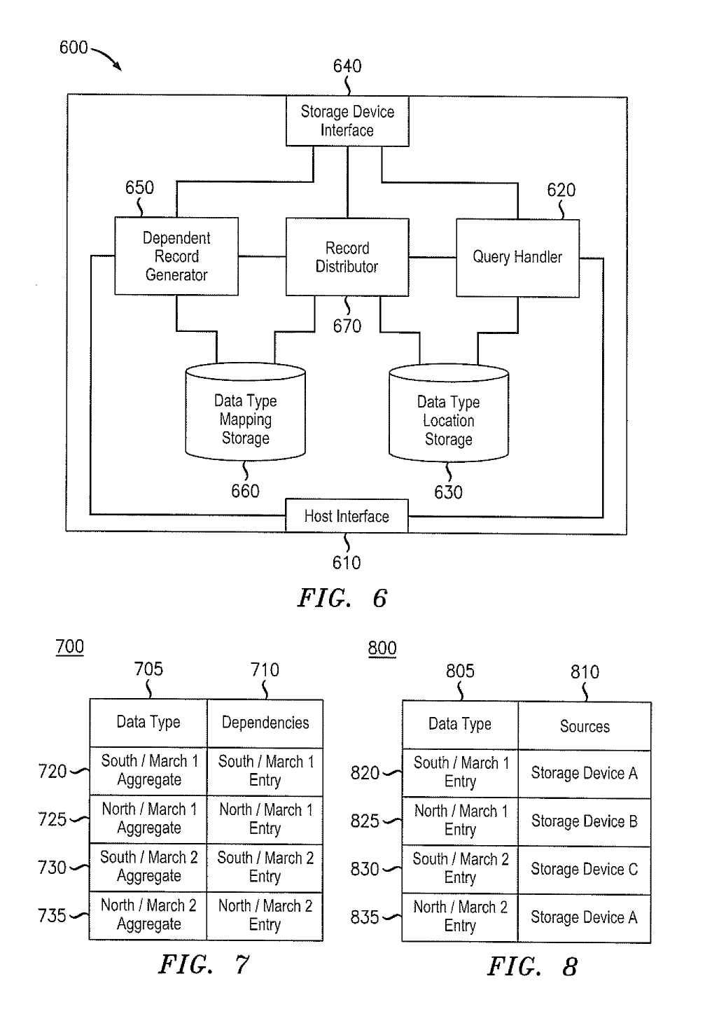

FIG. 6 illustrates an exemplary database controller 600 for distributing records among a plurality of storage devices. Database controller 600 may correspond to database controller 110 of exemplary system 100. Database controller may include a host interface 610, query handler 620, data type location storage 630, storage device interface 640, dependent record generator 650, data type mapping storage 660, and record distributor 670.

Host interface 610 may be an interface comprising hardware and/or executable instructions encoded on a machine-readable storage medium configured to communicate with one or more host devices such as, for example, host device 150. Accordingly, host interface 610 may include various types of interfaces such as, for example, an advanced technology attachment (ATA) interface, serial ATA (SATA) interface, small computer system interface (SCSI), serial attached SCSI (SAS), fibre channel interface, Ethernet interface, and/or Wi-Fi interface.

Query handler 620 may include hardware and/or executable instructions on a machine-readable storage medium configured to execute queries received via host interface 610. Accordingly, query handler 620 may be adapted to interpret queries formed according to various query languages. In fulfilling such queries, query handler 620 may store new records, modify existing records, and/or retrieve records, as specified by a received query. In locating existing records, query handler 620 may refer to data type location storage 630 to determine which storage devices actually store the requested data. When storing new and/or modified records, query handler 620 may pass the new records to record distributor 670 for storage on an appropriate storage device. After completing a query, query handler 620 may respond to an appropriate host device by transmitting a confirmation and/or a query result via host interface 610.

Data type location storage 630 may be any machine-readable medium capable of storing associations between various data types and storage devices on which such data types are stored. Accordingly, data type location storage 630 may include a machine-readable storage medium such as read-only memory (ROM), random-access memory (RAM), magnetic disk storage media, optical storage media, flash-memory devices, and/or similar storage media. In various alternative embodiments, data type location storage 630 may be an external device which may be accessed by one or more network nodes such as database controller 600. An exemplary data arrangement is described in further detail below with respect to FIG. 8.

Storage device interface 640 may be an interface comprising hardware and/or executable instructions encoded on a machine⁻readable storage medium configured to communicate with one or more storage devices such as, for example, storage device 120, 130, 140. Accordingly, storage device interface 640 may include various types of interfaces such as, for example, an advanced technology attachment (ATA) interface, serial ATA (SATA) interface, small computer system interface (SCSI), serial attached SCSI (SAS), fibre channel interface, Ethernet interface, and/or Wi-Fi interface.

Dependent record generator 650 may include hardware and/or executable instructions on a machine-readable storage medium configured to generate a number of dependent records for storage in the database. In various embodiments, dependent record generator 650 may create such dependent records, for example, upon receiving a request for such action via host interface 610 and/or automatically at scheduled times. Dependent records may be generated based on, or otherwise dependent upon, other records stored in the database. For example, a record of aggregated sales for a store on a particular date, may be dependent upon the individual sales entries for that store on that date.

Dependent record generator 650 may further be adapted to update data type mapping storage in view of newly generated dependent records. For example, upon generating a “South/March 1 Aggregate” record based on “South/March 1 Entry” records, dependent record generator 650 may update data type mapping storage 660 to reflect this dependency. Upon generating a dependent record, dependent record generator 650 may pass the dependent record to record distributor 670 for storage in an appropriate storage device. In various embodiments, dependent record generator 650 may pass each dependent record to record distributor 670 immediately upon creation of that record, or dependent record generator 650 may generate a set of dependent records and then pass the entire set to record distributor 670.

Data type mapping storage 660 may be any machine-readable medium capable of storing indications of on which storage devices various data types are stored. Accordingly, data type mapping storage 660 may include a machine-readable storage medium such as read-only memory (ROM), random-access memory (RAM), magnetic disk storage media, optical storage media, flash-memory devices, and/or similar storage media. In various alternative embodiments, data type mapping storage 660 may be an external device which may be accessed by one or more network nodes such as database controller 600. Further, in various embodiments, data type mapping storage 660 may be the same device as data type location storage 630. An exemplary data arrangement is described in further detail below with respect to FIG. 7.

Record distributor 670 may include hardware and/or executable instructions on a machine-readable storage medium configured to store records in various storage devices via storage device interface 640. In doing so, record distributor 670 may utilize data stored in data type location storage 630 and/or data type mapping storage 670. For example, upon receiving a record from query handler 620 or dependent record generator 650, record distributor may determine a data type of the record and, subsequently, determine if data type location storage indicates that such data type is already associated with a storage device. If so, record distributor 670 may simply store the record at such storage device. Otherwise, record distributor may select a storage device according to a distribution method such as round robin, store the record at the selected device, and subsequently update data type location storage to reflect the selected device.

In various embodiments, record distributor 670 may further determine whether a record is dependent on any other data types. For example, record distributor 670 may refer to data type mapping storage 660 to determine whether the data type of the present record depends on any other data types. If the current record has no dependencies, record distributor 670 may simply store the record according to the methods previously described. If the record is dependent on other data types, however, record distributor 670 may ensure that the dependent record is not stored on the same device as any record upon which it depends. For example, after selecting a storage device according to a distribution method such as round robin, record distributor may utilize data type location storage 630 to determine whether any of the data types upon which the record depends are stored on the selected storage device. If so, record distributor 670 may select another storage device for the dependent record according to the same or a different distribution method.

In various embodiments wherein record distributor 670 receives a set of records to store, record distributor 670 may be adapted to iterate through the data types in the set and store the records belonging to each data type together according to the methods described above. Record distributor 670 may further be adapted to maintain state information necessary or helpful in implementing various distribution methods. For example, in embodiments utilizing the round robin method, record distributor 670 may maintain an indication of the last storage device to which a record was transmitted for storage and/or an ordered list of storage devices.

FIG. 7 illustrates an exemplary data arrangement 700 for storing data type mappings. Data arrangement 700 may be a table in a database or cache such as data type mapping storage 660. Alternatively, data arrangement 700 may be a series of linked lists, an array, or a similar data structure. Thus, it should be apparent that data arrangement 700 is an abstraction of the underlying data; any data structure suitable for storage of this data may be used.

Data arrangement 700 may include a number of fields such as data type field 705 and dependencies field 710. Data type field 705 may indicate a data type to which a particular mapping entry corresponds. Dependencies field 710 may indicate one or more other data types upon which the data type indicated in data type field 705 depends.

As an example, mapping entry 720 may indicate that records having data type “South/March 1 Aggregate” depend upon the “South/March 1 Entry” data type. Likewise, mapping entry 725 may indicate that records having data type “North/March 1 Aggregate” depend upon the “North/March 1 Entry” data type. Further, mapping entry 730 may indicate that records having data type “South/March 2 Aggregate” depend upon the “South/March 2 Entry” data type. Finally, mapping entry 735 may indicate that records having data type “North/March 2 Aggregate” depend upon the “North/March 2 Entry” data type.

In various embodiments, some dependent records may depend upon other dependent records. For example, a record that stores a total number of sales for all stores on March 1 may depend on records of type “South/March 1 Aggregate” and “North/March 1 Aggregate[.]” In such embodiments, data arrangement 700 may store an additional mapping entry for the dependencies for this record type. In various embodiments, such mapping entry may additionally or alternatively identify the record as depending upon each of the “South/March 1 Entry” and “North/March 1 Entry” data types because the record may indirectly depend upon these data types. The new record may then be stored as described above in view of the dependencies identified in data arrangement 700.

FIG. 8 illustrates an exemplary data arrangement 800 for storing data type locations. Data arrangement 800 may be a table in a database or cache such as data type location storage 630. Alternatively, data arrangement 800 may be a series of linked lists, an array, or a similar data structure. Thus, it should be apparent that data arrangement 800 is an abstraction of the underlying data; any data structure suitable for storage of this data may be used.

Data arrangement 800 may include a number of fields such as data type field 805 and sources field 810. Data type field 805 may indicate a data type to which a particular location entry corresponds. Sources field 810 may indicate one or more storage devices that store records of the indicated data type.

As an example, location entry 820 may indicate that records of the “South/March 1 Entry” data type are stored on storage device A 120. Likewise, location entry 825 may indicate that records of the “North/March 1 Entry” data type are stored on storage device B 130. Further, location entry 830 may indicate that records of the “South/March 2 Entry” data type are stored on storage device C 140. Finally, location entry 835 may indicate that records of the “North/March 2 Entry” data type are stored on storage device A 120.

It will be apparent that exemplary data arrangement 800 does not illustrate records corresponding to the “South/March 1 Aggregate,” “North/March 1 Aggregate,” “South/March 2 Aggregate,” or “North/March 2 Aggregate,” data types. Accordingly to the present example, no record having any of these types may yet be stored in the database. For example, a database controller may have generated a number of such aggregate records, but may not yet have selected appropriate storage devices to store each such aggregate record.

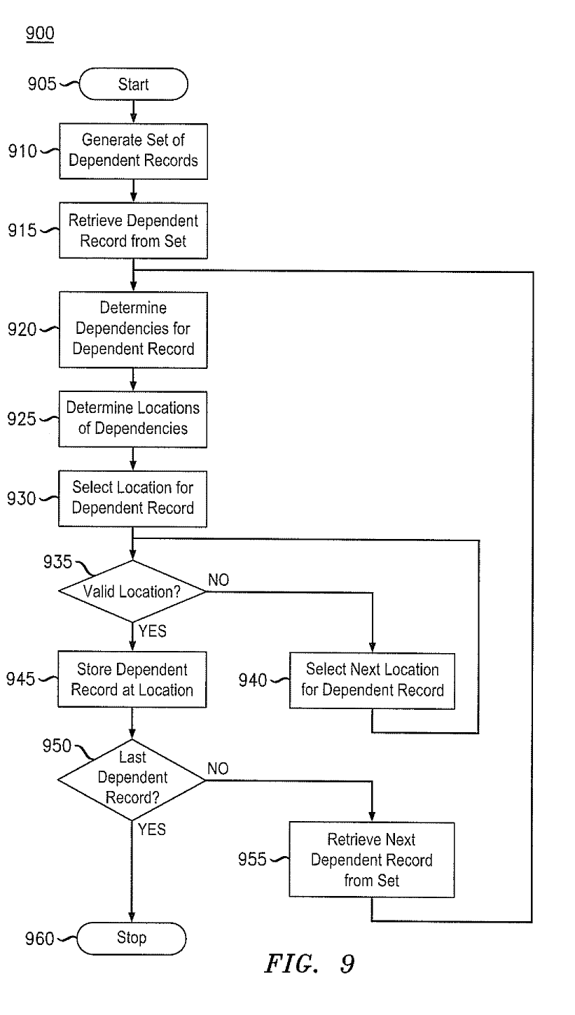

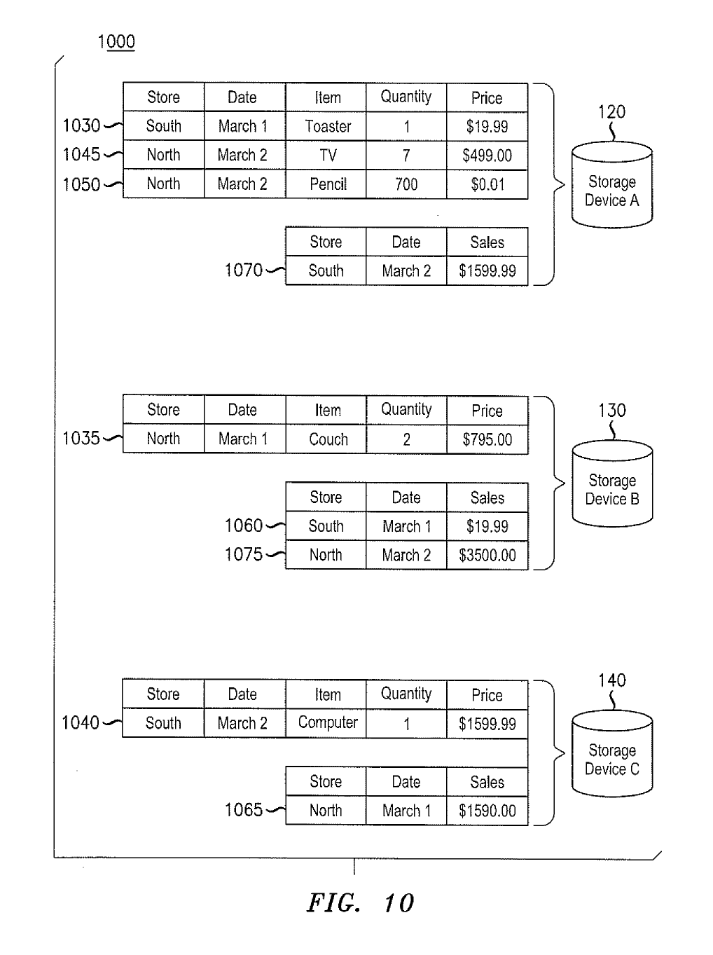

FIG. 9 illustrates an exemplary method 900 for distributing data sets among a number of storage devices. Method 900 may be performed by the components of database controller 600 such as, for example, dependent record generator 650 and/or record distributor 670.

Method 900 may begin in step 905 and proceed to step 910 where database controller 600 may generate a set of dependent records for storage in the database. For example, database controller may aggregate sales for different stores on different dates. Method 900 may then proceed to step 915, where database controller 600 may retrieve a first dependent record from the set to be stored. In various embodiments, this step may include retrieving a single record or all records of a first data type to be stored.

Next, in step 920, database controller 600 may identify any data types upon which the current dependent record or dependent record data type depends. Next, database controller 600 may determine, at step 925, at which storage locations each identified data type are stored. Method 900 may then proceed to step 930, where database controller 600 may select a location for the dependent record(s). For example, database controller 600 may utilize a data distribution method such as round robin to determine a candidate storage device for the current dependent record(s). Next, in step 935, database controller 600 may determine whether the selected location is valid. In various embodiments, this step may include determining whether the candidate storage device is included in the locations determined to store records upon which the current dependent record(s) depend in step 925.

If the first candidate location is not a valid location, method 900 may proceed to step 940 where database controller 600 may select a different candidate storage device for the current dependent record(s). For example, database controller 600 may simply select the next storage device according to the employed distribution method. Method 900 may then loop back around to step 935.

Once a valid location is selected, method 900 may proceed from step 935 to step 945 where database controller 600 may transmit the current dependent record(s) to the selected storage device for storage in the database. Method 900 may then proceed to step 950 where database controller 600 may determine whether additional dependent records remain to be stored. If the dependent record(s) that was just stored was not the last dependent record in the set, database controller 600 may retrieve the next dependent record or group of dependent records having the next data type in step 955. Method 955 may then loop back to step 920. Once the entire set has been stored, method 900 may proceed from step 950 to end in step 960.

FIG. 10 illustrates an exemplary distribution 1000 of data sets among a number of storage devices. Exemplary distribution 1000 may include data set 200 distributed in a similar manner to that described above in connection with FIG. 3. Exemplary distribution 1000 may also include data set 400, distributed in a manner as described above in connection with FIGS. 6-9.

Database controller 600 may begin by determining that data set 400 includes records of data types “South/March 1 Aggregate,” “North/March 1 Aggregate,” “South/March 2 Aggregate,” and “North/March 2 Aggregate.” Beginning with the “South/March 1 Aggregate” data type, database controller 600 may determine that, according to mapping entry 720, this data type may depend on the “South/March 1 Entry” data type. Next, database controller 600 may determine that, according to location entry 820, the “South/March 1 Entry” data type may be stored at storage device A 120.

Database controller 600 may then begin the process of selecting a storage device for data type “South/March 1 Aggregate,” by employing a data distribution method such as round robin to select the first storage device, storage device A 120. Next database controller 600 may determine that storage device A 120 stores the “South/March 1 Entry” data type, upon which the “South/March 1 Aggregate” data type depends. Accordingly, database controller 600 may proceed to select a different storage location. For example, database controller 600 may move on to the next storage device, storage device B 130. Storage device B 130 may be valid in view of the dependencies for the “South/March 1 Aggregate” data type and, accordingly, database controller 600 may store aggregate record 1060 at storage device B.

Database controller 600 may proceed in this manner, continuing to use the round robin method to select storage devices. As illustrated, database controller 600 may next store aggregate record 1065 in storage device C 140. This may be a valid storage location because aggregate record 1056 depends from sales record 1035, which is stored on a different storage device. Likewise, database controller 600 may store aggregate records 1070 and 1075 on storage device A 120 and storage device B 130, respectively, because these are valid locations in view of the locations of the sales records upon which these aggregate records depend. Thus, none of the aggregate records 1060, 1065, 1070, 1075 are stored on a device together with the records from which they depend.

According to the foregoing, various embodiments enable the optimization of storage and retrieval of data among a plurality of storage devices and leveraging of the independence of such storage devices from one another to improve system performance during compound database operations. In particular, by ensuring that a record is not stored on the same physical device as other records from which the record depends, the database system may ensure that operations that are likely to occur together are spread among a greater number of different storage devices.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a database controller for distributing data among a plurality of storage devices, the method comprising:
retrieving, by the database controller, a record to be stored;
identifying a record type associated with the record;
identifying at least one storage device of the plurality of storage devices that stores records of the identified record type; and
storing the record in a storage device of the plurality of storage devices other than the at least one storage device identified as storing records of the identified record type.

2. The method of claim 1, wherein the step of identifying a record type associated with the record comprises identifying a record type of at least one other record upon which the record depends.

3. The method of claim 2, wherein the record is an aggregate record based upon the at least one other record.

4. The method of claim 1, wherein a record type is at least partially defined by a value carried by records having that record type.

5. The method of claim 1, wherein the step of retrieving a record to be stored comprises retrieving a record from a set of records to be stored.

6. The method of claim 5, wherein the step of storing the record in a storage device of the plurality of storage devices other than the at least one storage device identified as storing records of the identified record type comprises:
selecting a first storage device of the plurality of storage devices according to a data distribution method applied to the set of records to be stored;
determining whether the first storage device is included in the at least one storage device identified as storing records of the identified record type; and
if the first storage device is included in the at least one storage device identified as storing records of the identified record type, selecting a second storage device of the plurality of storage devices.

7. The method of claim 6, wherein the data distribution method comprises round robin.

8. A system for distributing data among a plurality of storage devices, the system comprising:
a storage device interface for communicating with the plurality of storage devices;
a dependent record generator configured to generate a dependent record to be stored on the plurality of storage devices based upon at least one other record currently stored on the plurality of storage devices; and
a record distributor configured to:
identify a record type associated with the record,
identify at least one storage device of the plurality of storage devices that stores records of the identified record type, and
transmit the dependent record via the storage device interface to a storage device other than the at least one storage device identified as storing records of the identified record type.

9. The system of claim 8, wherein, in identifying a record type associated with the record, the record distributor is configured to identify a record type of the at least one other record currently stored on the plurality of storage devices.

10. The system of claim 8, wherein the record type is at least partially defined by a value carried by records having that record type.

11. The system of claim 8, wherein, in generating the dependent record, the dependent record generator is configured to generate a set of dependent records.

12. The system of claim 11, wherein, in transmitting the dependent record via the storage device interface to a storage device, the record distributor is configured to:
select a first storage device of the plurality of storage devices according to a data distribution method applied to the set of dependent records;
determine whether the first storage device is included in the at least one storage device identified as storing records of the identified record type; and
if the first storage device is included in the at least one storage device identified as storing records of the identified record type, select a second storage device of the plurality of storage devices.

13. The method of claim 12, wherein the data distribution method comprises round robin.

14. A tangible and non-transitory machine-readable medium encoded with instructions for execution on a database controller for distributing data among a plurality of storage devices, the machine-readable medium comprising:
instructions for retrieving, by the database controller, a record to be stored;
instructions for identifying a record type associated with the record;
instructions for identifying at least one storage device of the plurality of storage devices that stores records of the identified record type; and
instructions for storing the record in a storage device of the plurality of storage devices other than the at least one storage device identified as storing records of the identified record type.

15. The tangible and non-transitory machine-readable medium of claim 14, wherein the instructions for identifying a record type associated with the record comprise instructions for identifying a record type of at least one other record upon which the record depends.

16. The tangible and non-transitory machine-readable medium of claim 15, wherein the record is an aggregate record based upon the at least one other record.

17. The tangible and non-transitory machine-readable medium of claim 14, wherein a record type is at least partially defined by a value carried by records having that record type.

18. The tangible and non-transitory machine-readable medium of claim 14, wherein the instructions for retrieving a record to be stored comprise instructions for retrieving a record from a set of records to be stored.

19. The tangible and non-transitory machine-readable medium of claim 18, wherein the instructions for storing the record in a storage device of the plurality of storage devices other than the at least one storage device identified as storing records of the identified record type comprise:
instructions for selecting a first storage device of the plurality of storage devices according to a data distribution method applied to the set of records to be stored;
instructions for determining whether the first storage device is included in the at least one storage device identified as storing records of the identified record type; and
instructions for, if the first storage device is included in the at least one storage device identified as storing records of the identified record type, selecting a second storage device of the plurality of storage devices.

20. The tangible and non-transitory machine-readable medium of claim 19, wherein the data distribution method comprises round robin.
